(19) United States
(12) Patent Application Publication
(10) Pub. No.: US 2023/0413402 A1
(43) Pub. Date: Dec. 21, 2023

(54) NON-POLARIZED LIGHT STRING WITHOUT RECTIFICATION

(71) Applicant: ZHANGZHOU GO WIN LIGHTING CO., LTD, ZHANGZHOU (CN)

(72) Inventors: QINGAN WU, Zhangzhou (CN); Bihai Wang, Zhangzhou (CN); Yaying Huang, Zhangzhou (CN)

(21) Appl. No.: 17/857,033

(22) Filed: Jul. 3, 2022

(30) Foreign Application Priority Data
Jun. 16, 2022 (CN) 202210683306.6

(51) Int. Cl. H05B 45/46; H05B 45/42

(52) U.S. Cl. CPC H05B 45/46; H05B 45/42

(57) ABSTRACT

The present disclosure provides a non-polarized light string without rectification which includes LED modules connected in parallel to a pair of conductive wires. Each LED module includes a current-limiting resistor and LED units. A first terminal of the current-limiting resistor is connected to one conductive wire, a second terminal of the current-limiting resistor is connected to the LED units, the LED units are connected in series, then connected to the other conductive wire. The pair of light-emitting diodes of the same LED unit are integrated on one chip, the distance between the lighting parts of the two light-emitting diodes is controlled to less than 1 mil, and electrodes of opposite polarity of the two light-emitting diodes are connected to each other in parallel, so that under the AC power supply, there is always one light-emitting diode being light up during a whole cycle of the AC power.

### CROSS REFERENCE TO RELATED APPLICATIONS

This application is based upon and claims priority to Chinese Patent Application No. 202210683306.6, filed on Jun. 16, 2022, the entire contents of which are incorporated herein by reference.

### TECHNICAL FIELD

The present disclosure relates to the field of LED lighting, in particular to a non-polarized light string without rectification.

### BACKGROUND

LED lights are widely used in various fields owing to its low power consumption, less heat production, and long service life, etc. For example, LED lights may be connected in series or parallel to make a light strip or light string for decoration and creating atmosphere and ambience. Usually, to produce a LED light string, LED light beads and SMD resistors are mounted on a strip-shaped flexible printed circuit board (FPCB) or a printed circuit board (PCB), then undergoes packaging processes, such as encapsulation, etc. Additionally, the light strip is supplied with power by an external power supply with rectifier bridge.

Under the widespread and wide range of use of LED lights, some problems of LED light strings have also been discovered and paid attention. Strobing or flicker is one of those hot spots in the research area of LED field. It is reported by professional researches that the strobing of LED light source is essentially caused by the reason that changes of the light emitted by the light source follow certain frequency and is periodic against time, namely, the brightness and color of light changes against time. Simply put, the light energy fluctuates at a certain frequency. The strobing of LED light can also be felt and directly observed by the stripes appearing on the screen of a mobile phone when the camera is pointed to an LED light source. Severe strobing or flicker will cause illusions to the human eyes, which will lead to accidents or physical discomfort. It should be noted that the human eyes are a very complex system which distinctly differs for different individuals. For most people, flicker with frequency lower than 80 Hz can be felt and caught. In this case, the human eyes can feel the brightness change, so the flicker with frequency below 80 Hz is also called visible flicker. Therefore, visible flicker is unacceptable for ordinary lighting or display. Meanwhile, although flicker with frequency higher than 80 Hz is hard to be felt by human eyes, it has a great impact on the spatial perception of the human eyes. For example, a moving object may wrongly be captured as a series of stationary frames, that is, the stroboscopic effect, which may cause illusion. It is very dangerous to misunderstand a quick running equipment as slowly running or even stationary.

As a major means for decoration and creating atmosphere and ambience, the strobing and flicker of LED light strings cannot be ignored. Some designers believe that a pure and constant current source should be obtained to eliminate the strobing and flicker of LED lights, so LED driver is the key point. Simply speaking, LED power supply without flicker or strobing can be achieved regarding the current technical level. Technically, there are three major ways to improve or eliminate the stroboscopic effect of LED lights: 1. increase capacity of the output electrolytic capacitor; 2. use valley-fill passive PFC circuit; 3. use two-stage circuit. In practice, some designers connect two LED lights in parallel with the LED units of the LED light string with electrodes of opposite polarity connected to each other, and then set capacitors and rectifier bridges on the power supply wires to depress the stroboscopic effect. In this solution, when the LED light string is powered by mains electric power, in one AC cycle of the mains electric power, LED chip only lights on for a half cycle and during the other half cycle the LED chip is off. With the capacitor featured charging and discharging, when the alternating current changes direction in a cycle, the capacitor will discharge by itself, so that the capacitor will automatically charge and discharge according to the direction change of the alternating current in each cycle. When the capacitor discharges, the LED light turned on during the charging process of the capacitor will continue to illuminate for a period of time so that a pair of LED lights connected in parallel with positive and negative electrodes connected in reverse can better transition between on and off of the light to make users hard to feel the flicker of the LED light string visually. However, the more electronic components in the LED light string, the higher the cost, and at the same time, the factors that may cause failure will also increase. How to simplify the electronic components as much as possible while still guaranteeing the anti-stroboscopic ability of light strings is a research topic with practical significance and market value.

### SUMMARY

In view of the above problem, one object of the present disclosure is to provide a non-polarized light string without rectification that is reliable to implement, stable, and can effectively avoid visible flicker.

In order to realize the above-mentioned object, the present disclosure provides the following solution.

A non-polarized light string without rectification includes a pair of conductive wires for connecting with a power supply and more than one LED modules connected in parallel to the pair of conductive wires, each LED module includes a current-limiting resistor and more than one LED unit, a first terminal of the current-limiting resistor is connected to one conductive wire, a second terminal of the current-limiting resistor is connected to the LED units, the LED units are connected in series, then connected to the other conductive wire;
each LED unit includes a pair of light-emitting diodes connected in parallel, a positive electrode and a negative electrode of one light-emitting diode are correspondingly connected to a negative electrode and a positive electrode of the other light-emitting diode with electrodes of opposite polarity connected to each other;
the pair of light-emitting diodes of each LED unit are integrated on one chip with a distance between lighting parts of the pair of light-emitting diodes less than 1 mil.

As a possible implementation, further, each LED unit includes a light bowl, and the pair of light emitting diodes are located in the same light bowl.

As a possible implementation, further, an illumination angle of the pair of light emitting diodes of each LED unit both ranges from 15 degrees to 60 degrees.

As a possible implementation, further, the power supply is mains electric power.

As a possible implementation, the non-polarized light string without rectification further includes a front plug and a rear plug, the front plug is connected to a first end of the pair of conductive wires, and the rear plug is connected to a second end of the pair of conductive wires.

As a preferred implementation, the pair of conductive wires are both provided with a fuse or one of the conductive wires is provided with a fuse.

As a preferred implementation, the fuse has a rated current of 3 A and a rated voltage of 125V.

As a possible implementation, further, the current-limiting resistor is a 1206 SMD resistor with a resistance value of 3Ω.

As a preferred implementation, the pair of light-emitting diodes of each LED unit are of the same color.

Compared with the prior art, the present disclosure has the following advantages. According to the present disclosure, the pair of light-emitting diodes of the same LED unit are integrated on one chip, the distance between the lighting parts of the two light-emitting diodes is controlled to less than 1 mil, and electrodes of opposite polarity of the two light-emitting diodes are connected to each other in parallel, so that under the AC power supply (e.g. mains electric power), there is always one light-emitting diode among the two of each LED unit being light up during a whole cycle of the AC power. Meanwhile, when the AC power is changing its direction and the working diode is being shifted from one to the other, since the distance between the lighting parts of the two diodes is within 1 mil, illumination region of the later light-emitting diode can quickly cover the illumination region of the previous light-emitting diode, so as to effectively avoid visible flicker. By doing so, the downside of using capacitors to avoid visible flicker will no longer exist and rectifier bridge may also be omitted. According to the configuration of the present disclosure, the illumination angle of the pair of light-emitting diodes of each LED unit ranges 15-60 degrees, within this angle range, visible flicker can be effectively avoided. When a plurality of LED units are connected in series to form a light module, and a plurality of light modules are connected to form a light string assembly, the device can work reliably and effectively to create desired ambience and atmosphere, so as to provide high-quality effects.

### BRIEF DESCRIPTION OF THE DRAWINGS

In order to clearly explain the embodiments of the present disclosure or the technical solutions in the prior art, the drawings that would be used in describing the embodiments or the prior art will briefly introduced below. Obviously, the drawings illustrated below merely include some of the embodiments of the present disclosure. For those of ordinary skill in the art, other drawings may be derived from these drawings without creative effort.

FIG. 1 is schematic diagram briefly showing the modular connection according to one embodiment of the present disclosure.

FIG. 2 is a circuit diagram according to one embodiment of the present disclosure.

FIG. 3 is schematic diagram briefly showing the modular connection of an expanded mode according to one embodiment of the present disclosure.

FIG. 4 is a schematic diagram showing some elements (maybe a part of or all elements) of an LED unit for illustrating the arrangement relationship of the pair of light-emitting diodes, according to one embodiment of the present disclosure.

FIG. 5 is a schematic diagram showing the illumination region of a pair of light-emitting diodes of one LED unit with an illumination angle of 15 degrees for illustrative purpose according to one embodiment of the present disclosure.

FIG. 6 is a schematic diagram showing the illumination region of a pair of light-emitting diodes of one LED unit with an illumination angle of 60 degrees for illustrative purpose according to one embodiment of the present disclosure.

### DETAILED DESCRIPTION OF THE EMBODIMENTS

The present disclosure will be described in detail with reference to the drawings and embodiments hereinafter. It should be noted that the embodiments described below are merely intended to illustrate the present disclosure rather than limit the scope of protection of the present disclosure. Likewise, the following embodiments merely cover part of the embodiments of the present disclosure rather than all. All other embodiments derived by a person of ordinary skill in the art based on the present disclosure without creative effort shall be considered as fall within the scope of the present disclosure.

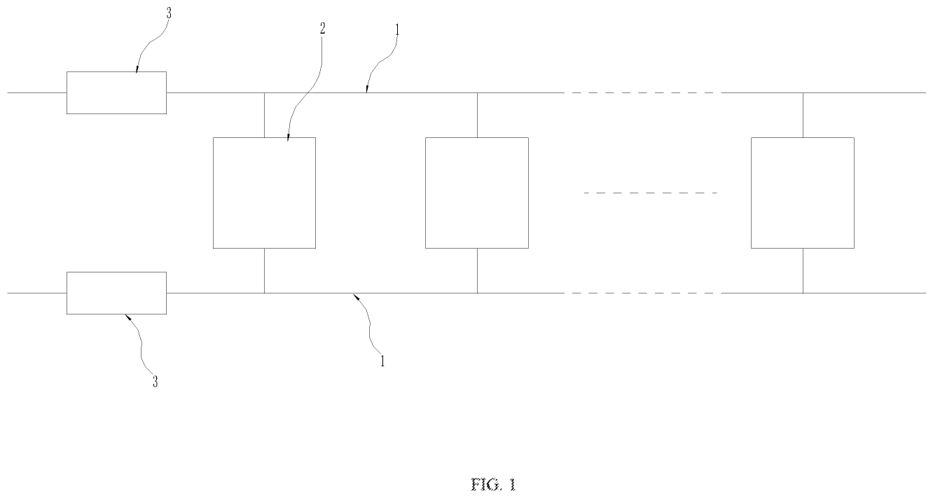

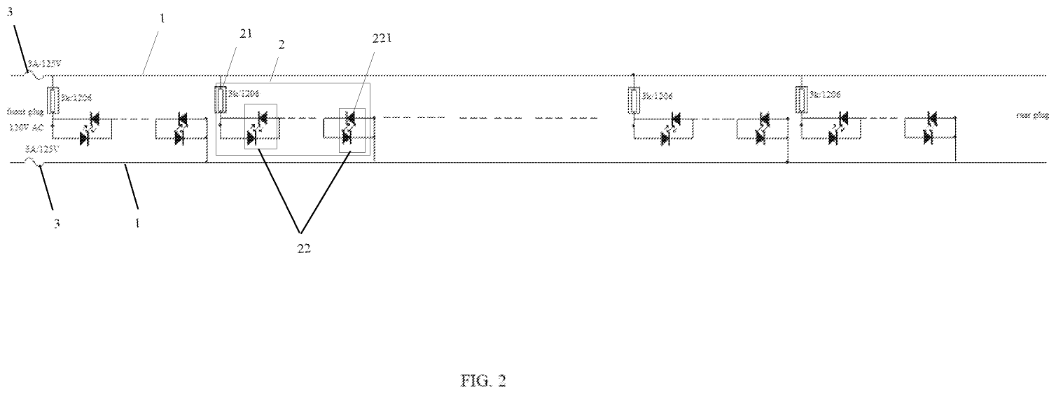

As shown in FIG. 1 or FIG. 2, the present embodiment provides a non-polarized light string without rectification that includes a pair of conductive wires 1 for connecting to a power supply (mains electric power) and more than one LED modules 2 connected in parallel to the pair of conductive wires 1. Each LED module 2 includes a current-limiting resistor 21 and more than one LED unit 22, a first terminal of the current-limiting resistor 21 is connected to one conductive wire 1, a second terminal of the current-limiting resistor 21 is connected to the LED units 22, the LED units 22 are connected in series, then connected to the other conductive wire 1.

Referring to FIG. 2, the LED unit 22 includes a pair of light-emitting diodes 221 connected in parallel, and a positive electrode and a negative electrode of one light-emitting diode are correspondingly connected to a negative electrode and a positive electrode of the other light-emitting diode with electrodes of opposite polarity connected to each other. In the present embodiment, the pair of light-emitting diodes 221 of the LED unit 22 are of the same color.

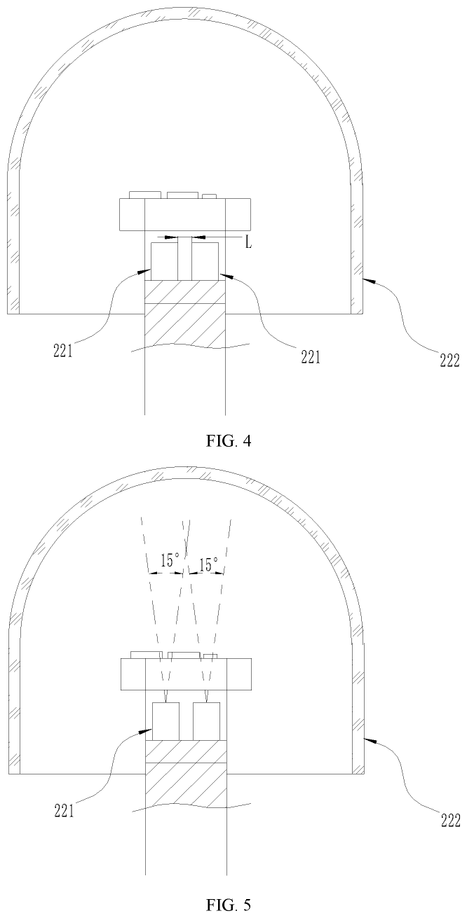

Referring to FIGS. 1, 2 and 4, the pair of light-emitting diodes 221 of each LED unit 22 are integrated on one chip with a distance L between lighting parts of the pair of light-emitting diodes 221 less than 1 mil.

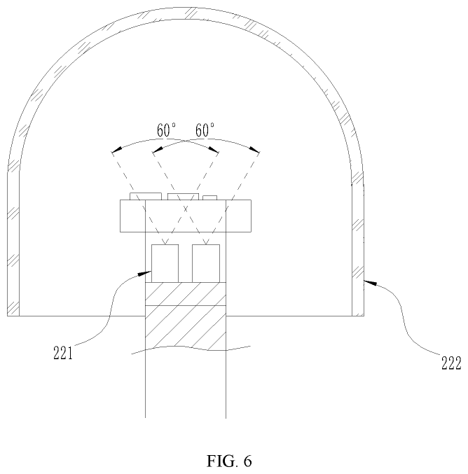

Referring to FIGS. 1, 2 and 4 or 6, in order to avoid visible flicker, each LED unit 22 may further include a light bowl 222, and the pair of light emitting diodes 221 are located in the same light bowl 222. An illumination angle of the pair of light emitting diodes 221 of each LED unit 22 both ranges from 15 degrees to 60 degrees. For example, the illumination angle may be 15, 30, 45, or 60 degrees. FIG. 5 is a schematic diagram showing the illumination region of a pair of light-emitting diodes 221 of one LED unit 22 with an illumination angle of 15 degrees for illustrative purpose. It can be learned from the drawing that when the illumination angle of the pair of light-emitting diodes 221 is 15 degrees, the junction where the illumination regions of the two light-emitting diodes 221 overlap do not fall outside the space defined by the light bowl 222. FIG. 6 is a schematic diagram showing the illumination region of a pair of light-emitting diodes 221 of one LED unit 22 with an illumination angle of 60 degrees for illustrative purpose. It can be learned from the drawing that when the illumination angle of the pair of light-emitting diodes 221 is 60 degrees, the junction where the illumination regions of the two light-emitting diodes 221 overlap do not fall outside the space defined by the light bowl 222.

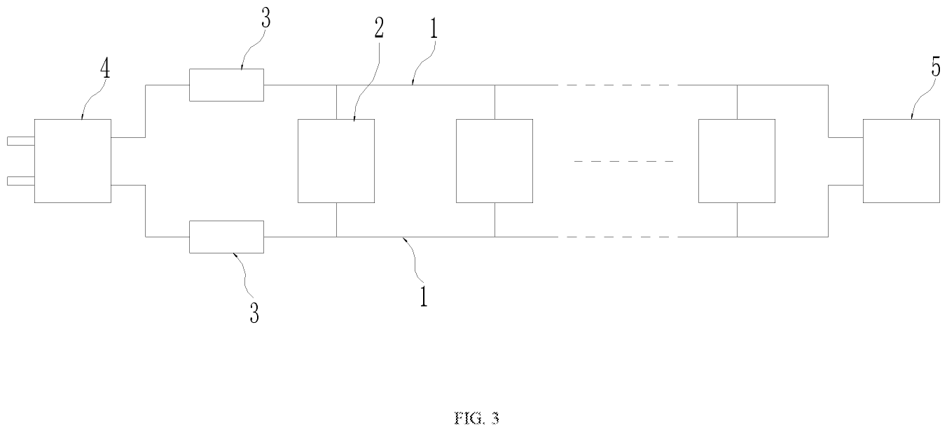

Referring to FIG. 3, in order to facilitate the serial connection of multiple light strips, a front plug 4 and a rear plug 5 may further be provided. The front plug 4 is connected to a first end of the pair of conductive wires 1, and the rear plug 5 is connected to a second end of the pair of conductive wires 1. The front plug 4 and rear plug 5 may act as a socket and a plug that are matched to each other, so that multiple non-polarized light strings may connected together in series to obtain a combined light string with longer length. Further, the combined light string may also be disassembled to achieve multiple light strings that can be used independently. Thus, the light string of the present disclosure is practical and flexible. Further, when one or more LED units of the non-polarized light string fail and stop work, the light string on which the faulty LED unit is located can be removed directly, so the maintenance is convenient and efficient.

Furthermore, in this solution, the pair of conductive wires 1 are both provided with a fuse 3 or one of the conductive wires 1 is provided with a fuse 3 to prevent short circuit of the light string due to over current. As a preferred embodiment, fuse with a rated current of 3 A and a rated voltage of 125V may be selected, but the present disclosure is not limited thereto, fuse of other specification may also be used. In terms of the selection of the current-limiting resistor 21, as a possible implementation, the current-limiting resistor 21 may be a 1206 SMD resistor or chip resistor with a resistance of 3Ω.

The working principle of the above embodiment is described below.

The non-polarized light string of the present embodiment is connected to the mains electric power, during a positive half cycle of the AC power, electricity passes through one of the two light-emitting diodes 221 of the LED unit 22 to light up the LED unit 22, while during the negative half cycle of the AC power, the electricity passed through the other one of the two light-emitting diodes 221 of the LED unit 22. Namely, the pair of light emitting diodes 221 of the LED unit work alternatively and shifted to one another. Since the distance L between the lighting parts of the pair of light-emitting diodes is within 1 mil, and due to the persistence of vision and the afterglow effect of the fluorescent material, the user's eyes would not able to catch the alternating process of the two light-emitting diodes, so that the anti-flickering effect of the light string may be achieved.

The above descriptions merely include part of the embodiments of the present disclosure, and the scope of protection of the present disclosure is not limited to these embodiments. Any equivalent device or equivalent process transformation made based on the content of the description and drawings of the present disclosure, or direct or indirect application of the present disclosure to other related technical fields should be considered as fall within the scope of the present disclosure.

1. A non-polarized light string without rectification, comprising a pair of conductive wires for connecting with a power supply and more than one LED modules connected in parallel to the pair of conductive wires; wherein
each LED module comprises a current-limiting resistor and more than one LED unit, a first terminal of the current-limiting resistor is connected to one conductive wire, a second terminal of the current-limiting resistor is connected to the LED units, and the LED units are connected in series, then connected to the other conductive wire;
each LED unit comprises one first light-emitting diode and one second light-emitting diode connected in parallel, a positive electrode and a negative electrode of the first light-emitting diode are correspondingly connected to a negative electrode and a positive electrode of the second light-emitting diode with electrodes of opposite polarity connected to each other;
the first light-emitting diode and the second light-emitting diode of each LED unit are integrated on one chip with a distance between lighting parts of the pair of light-emitting diodes less than 1 mil, and each LED unit further comprises a light bowl, and the first light emitting diode and second light emitting diode are located in the same light bowl, such that an illumination region of a later light-emitting diode can quickly cover an illumination region of a previous light-emitting diode, so as to effectively avoid visible flicker.

2. (canceled)

3. The non-polarized light string without rectification according to claim 1, wherein an illumination angle of the pair of light emitting diodes of each LED unit both ranges from 15 degrees to 60 degrees.

4. The non-polarized light string without rectification according to claim 1, wherein the power supply is mains electric power.

5. The non-polarized light string without rectification according to claim 1, wherein the non-polarized light string without rectification further comprises a front plug and a rear plug, the front plug is connected to a first end of the pair of conductive wires, and the rear plug is connected to a second end of the pair of conductive wires.

6. The non-polarized light string without rectification according to claim 1, wherein the pair of conductive wires are both provided with a fuse or one of the conductive wires is provided with a fuse.

7. The non-polarized light string without rectification according to claim 6, wherein the fuse has a rated current of 3 A and a rated voltage of 125V.

8. The non-polarized light string without rectification according to claim 1, wherein the current-limiting resistor is a 1206 SMD resistor with a resistance value of 3KΩ.

9. The non-polarized light string without rectification according to claim 1, wherein the pair of light-emitting diodes of each LED unit are of the same color.
